(19) United States
(12) Patent Application Publication
(10) Pub. No.: US 2026/0299230 A1
(43) Pub. Date: Oct. 1, 2026

(54) OPTICAL MODULE WITH PHOTONIC CHIP AND CARRIER

(71) Applicant: Global Technology Inc., Ningbo (CN)

(72) Inventors: Jian-Hong LUO, Ningbo (CN); Qilin Hong, Ningbo (CN); Taotao Ye, Ningbo (CN); Jiahang Shao, Ningbo (CN)

(21) Appl. No.: 19/290,132

(22) Filed: Aug. 4, 2025

(30) Foreign Application Priority Data
Mar. 25, 2025 (CN) 202510361423.4

(51) Int. Cl. G02B 6/42

(52) U.S. Cl. CPC G02B 6/4278; G02B 6/4257; G02B 6/4261; G02B 6/428

(57) ABSTRACT

The present disclosure provides an optical module including a substrate, a carrier, a photonic chip, and an optical transmission assembly. The substrate includes a first body having a mounting surface and a recessed space recessed from the mounting surface. The carrier includes a second body and two first flanges. The second body has a carrier surface, and the two first flanges are disposed on opposite sides of the second body, respectively. The two first flanges are coupled to the mounting surface. At least a part of the carrier surface is disposed within the recessed space. The photonic chip includes a waveguide layer and a cladding layer stacked with each other. The cladding layer faces and coupled to the mounting surface. The photonic chip and the carrier are spatially separated. The optical transmission assembly is coupled to the carrier surface and optically coupled to the waveguide layer.

### CROSS-REFERENCE TO RELATED APPLICATIONS

This non-provisional application claims priority under 35 U.S.C. § 119(a) on Patent Application No(s). 202510361423.4 filed in China on Mar. 25^{th}, 2025, the entire contents of which are hereby incorporated by reference.

### BACKGROUND

### 1. Technical Field

This disclosure relates to an optical module with photonic chip and carrier.

### 2. Related Art

An optical module may transmit and/or receive an optical signal for applications such as, but not limited to, a data center, a cable television (Cable TV) and a fiber to the home (FTTH). Using an optical module to transmit may provide higher transmission rate and signal bandwidth under longer transmission distance. To facilitate the compatibility of global optical internet products and reduce maintenance burden, organizations such as Multi-Source Agreement (MSA), Institute of Electrical and Electronics Engineers (IEEE) and Optical Internetworking Forum (OIF) develop a plurality of form factors suitable for different signal transmission rates. These form factors include but not limited to XFP, SFP, Quad Small Form Factor Pluggable (QSFP), QSFP- Double Density (DD), Octal Small Form Factor Pluggable (OSFP) and Co-Packaged Optics (CPO).

Existing optical modules face challenges such as reliability, manufacturing cost, optical power, space management and thermal management.

### SUMMARY

According to one or more embodiment of this disclosure, an optical module includes a substrate, a carrier, a photonic chip, and an optical transmission assembly. The substrate includes a first body. The first body has a mounting surface and a recessed space. The recessed space is recessed from the mounting surface. The carrier includes a second body and two first flanges. The second body has a carrier surface. The two first flanges are respectively disposed on opposite sides of the second body. The two first flanges are coupled to the mounting surface of the substrate. At least a portion of the second body is disposed within the recessed space. The photonic chip includes a waveguide layer and a cladding layer stacked with each other. The cladding layer faces and coupled to the mounting surface of the substrate. The photonic chip and the carrier are spatially separated. The optical transmission assembly is coupled to the carrier surface and optically coupled to the waveguide layer.

According to one or more embodiment of this disclosure, an optical module includes a substrate, a carrier, a photonic chip, and an optical transmission assembly. The substrate includes a first body. The first body has a mounting surface, a back surface and a recessed space. The mounting surface and the back surface are opposite to each other. The recessed space is recessed from the mounting surface. The carrier includes a second body. The second body has a carrier surface. At least a portion of the second body is disposed within the recessed space. The carrier surface is disposed between the mounting surface and the back surface. The photonic chip is coupled to the mounting surface of the substrate by flip-chip bonding. The optical transmission assembly is coupled to the carrier surface and optically coupled to an edge of the waveguide layer of the photonic chip.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a three-dimensional schematic diagram of an optical module according to the present disclosure;

FIG. 2 is a breakdown diagram of the optical module shown in FIG. 1;

FIG. 3 is a partially enlarged top view of the optical module shown in FIG. 1.

FIG. 4 is a cross-sectional diagram along the line 4-4 in FIG. 3;

FIG. 5 is a cross-sectional diagram along the line 5-5 in FIG. 3; and

FIG. 6 is a cross-sectional diagram along the line 6-6 in FIG. 3.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

With the rapid development of artificial intelligence technology, the market demand for multi-channel high-speed optical modules has significantly increased, promoting the rapid growth of communication system’s upgradation and the need of communication bandwidth. Recently, the application of photonic chips in optical modules has attracted growing attention. Generally, photonic chips adopt a wire-bonding configuration. More specifically, in order to mount the photonic chip on a printed circuit board assembly (PCBA), the electrical connection between the photonic chip and PCBA is realized by wire bonding. The inventors realized that the photonic chip in current optical modules often involves wire-bonding design to ensure higher integration density and manufacturing compatibility. However, the wire-bonding configuration has an adverse impact on high-frequency performance and optical coupling efficiency.

According to an embodiment of the present disclosure, at least a portion of the second body of the carrier is within a recessed space of a substrate, and a cladding layer of the photonic chip is coupled to a mounting surface of the substrate. Thus, the reliability of the optical module can be enhanced. In addition, the photonic chip is coupled to the substrate, and the optical transmission assembly is coupled to the carrier that exhibits lower thermal deformation, such that any negative impact on optical coupling efficiency caused by thermal deformation of the substrate can be reduced.

A person skilled in the art may reasonably combine and arrange the following disclosed technical features to achieve the corresponding technical effects.

The term “coupled” or “coupling” refers to any connection, linkage, or similar relationship. The term “optically coupled” or “optically coupling” refers to a relationship in which light is imparted from one component to another. Unless otherwise specified, components that are coupled to or coupling with each other do not need to be directly connected to each other and may be spaced apart via one or more intermediate components.

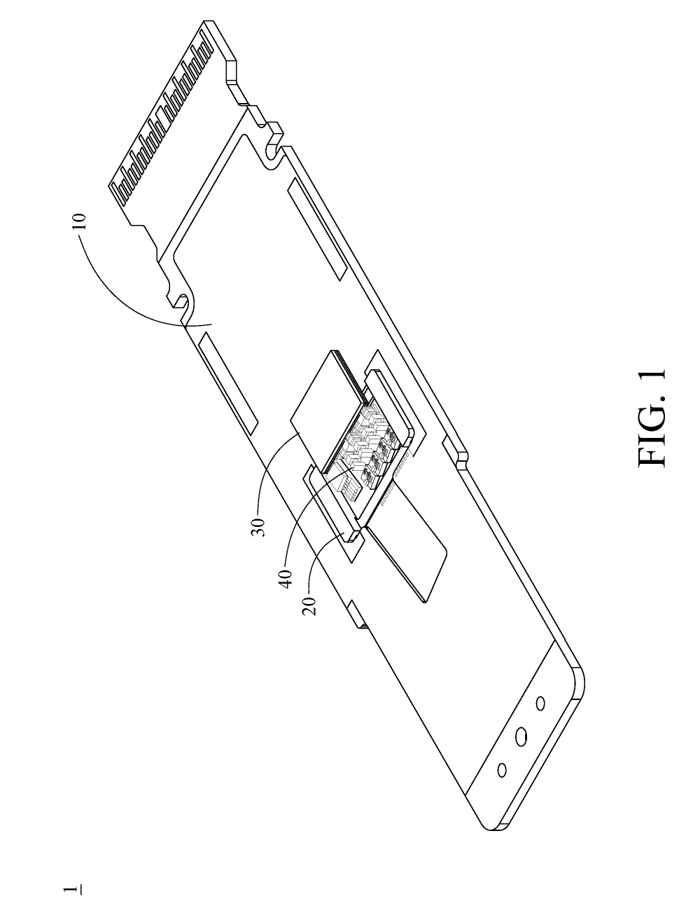

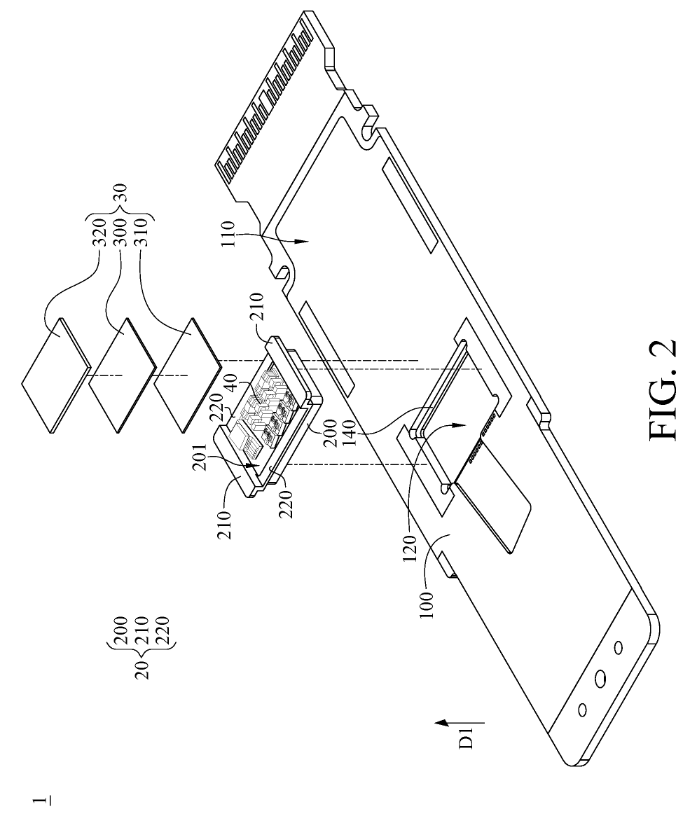

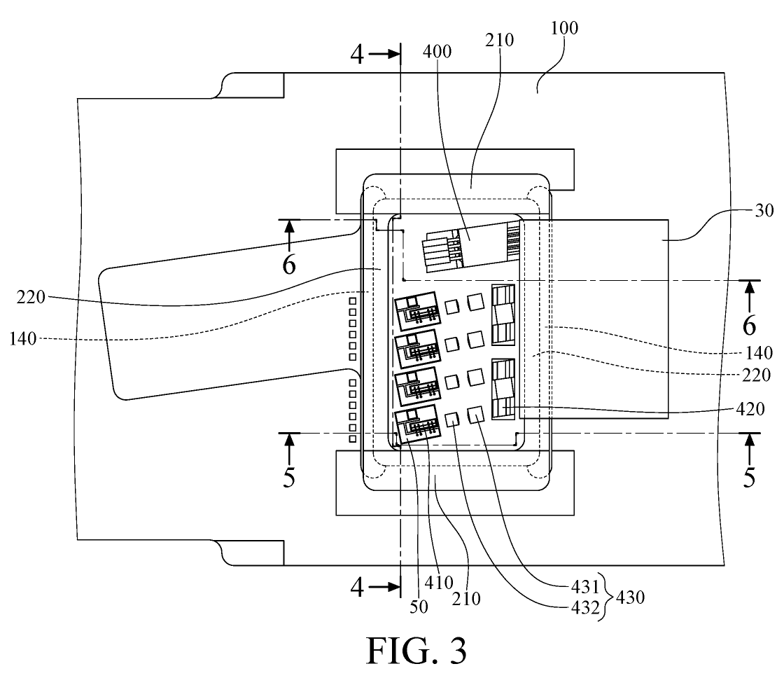

FIG. 1 is a three-dimensional schematic diagram of an optical module according to the present disclosure, FIG. 2 is a breakdown diagram of the optical module shown in FIG. 1, and FIG. 3 is a partially enlarged top view of the optical module shown in FIG. 1. According to an embodiment, the optical module 1 may include a substrate 10, a carrier 20, a photonic chip 30, and an optical transmission assembly 40.

In an embodiment, the substrate 10 may be a PCBA. In an embodiment, the substrate 10 may include a first body 100 and electronic components (not shown). Said electronic component may be, for example, a resistor, a capacitor, or a digital signal processor (DSP). In an embodiment, the first body 100 may have a mounting surface 110, a recessed space 120 and a back surface 130. In an embodiment, the recessed space 120 may be recessed from the mounting surface 110. In an embodiment, the mounting surface 110 and the back surface 130 may be opposite to each other. In an embodiment, the electronic components may be mounted at either the mounting surface 110 or the back surface 130 of the first body 100. In an embodiment, the mounting surface 110 and the back surface 130 may be understood as the top surface and bottom surface of a PCB, respectively.

In an embodiment, the carrier 20 may include a second body 200 and two first flanges 210. In an embodiment, the second body 200 may have a carrier surface 201 disposed between the mounting surface 110 and the back surface 130 in the thickness direction D1. In an embodiment, the two first flanges 210 may be respectively disposed on opposite sides of the second body 200. In an embodiment, the two first flanges 210 may be coupled to the mounting surface 110 of the substrate 10 to be positioned with the substrate 10. In an embodiment, at least a portion of the second body 200 may be disposed within the recessed space 120. In an embodiment, the carrier surface 201 of the second body 200 may also be within the recessed space 120. In an embodiment, the carrier 20 may be made of metal, and the carrier 20 may be mounted to the mounting surface 110 by glue or soldering.

In an embodiment, the first body 100 may further include two engagement portions 140. In an embodiment, the carrier 20 may further include two second flanges 220. In an embodiment, each engagement portion 140 may be a flange extending from the edge of the recessed space 120 toward the center of the same. In an embodiment, the two engagement portions 140 may be respectively disposed on opposites sides of the second body 200. In an embodiment, the two second flanges 220 may be disposed to correspond to the two engagement portions 140. In an embodiment, the two first flanges 210 may be disposed to not correspond to the two engagement portions 140. In an embodiment, the two second flanges 220 may be disposed between the two first flanges 210 and the second body 200 in the thickness direction D1. In an embodiment, the topmost of the second flange 220 is at a lower position than the topmost of the first flange 210 in the thickness direction D1.

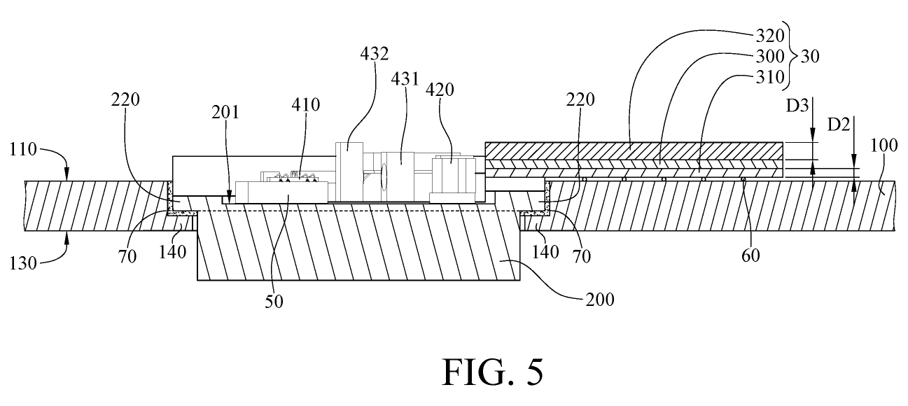

In an embodiment, the flange 220 and the engagement portion 140 of the carrier 20 may not contact each other directly. In an embodiment, a structural adhesive 70 (see FIG. 5) may be provided between the flange 220 and the engagement portion 140 to increase the structural strength of the optical module 1 and to prevent external substances, such as moisture, from entering the optical module 1 through the gap between the second flange 220 and the engagement portion 140, which could otherwise affect the operation of the optical module 1.

In an embodiment, the photonic chip 30 may be coupled to the mounting surface 110 of the substrate 10 by flip-chip bonding. In an embodiment, the photonic chip 30 may be a silicon photonic chip or a lithium niobate chip. In an embodiment, the photonic chip 30 may include a waveguide layer 300 and a cladding layer 310 stacked with each other. In an embodiment, the cladding layer 310 may face and coupled to the mounting surface 110 of the substrate 10. In an embodiment, the photonic chip 30 may be spatially separated from the carrier 20, which is advantageous for reducing the negative impact of the manufacturing tolerance of the carrier 20 on the optical coupling efficiency. In an embodiment, the photonic chip 30 is not coupled to the carrier 20, so that no significant shear force is generated between the photonic chip 30 and the carrier 20 when the photonic chip 30 shifts due to deformation of the substrate 10.

In an embodiment, along the thickness direction D1 of the substrate 10, the mounting surface 110 may be between the waveguide layer 300 and the carrier surface 201.

In an embodiment, the photonic chip 30 may further include a substrate layer 320. In an embodiment, the waveguide layer 300 may be disposed between the substrate layer 320 and the cladding layer 310. In an embodiment, the distance D2 between the waveguide layer 300 and the cladding layer 310 may be less than the distance D3 between the waveguide layer 300 and the substrate layer 320 (see FIG. 5). In FIG. 5, the distance D2 may be understood as the thickness of the cladding layer 310, and the distance D3 may be understood as the thickness of the substrate layer 320.

The photonic chip 30 may include a planar lightwave circuit (PLC) structure. Referring to FIG. 5, the waveguide layer 300 may include the core layer of the PLC structure, and the cladding layer 310 may include the cladding layer of the PLC structure. In an embodiment where the photonic chip 30 is a silicon photonic chip, the substrate layer 320 may be a silicon (Si) substrate, the waveguide layer 300 may be a silicon oxide (SiOx) layer, and the cladding layer 310 may be a silicon layer, a SiOx layer , or a thin film metal layer. The manufacturing process of the PLC structure may include forming the waveguide layer 300 on the substrate layer 320 through deposition and/or etching, followed by forming the cladding layer 310 to cover the waveguide layer 300.

In an embodiment, a portion of the waveguide layer 300 may cover a portion of the recessed space 120. As shown in FIG. 5, one end of the waveguide layer 300 may extend beyond the edge of the recessed space 120 and above the carrier surface 201 of the carrier 20, such that this end of the waveguide layer 300 overlaps with a portion of the recessed space 120 in the thickness direction D1. In an embodiment, the end of the waveguide layer 300 may extend beyond the second flange 220 and above an area of the carrier surface 201.

In an embodiment, the optical transmission assembly 40 may be coupled to the carrier surface 201 and optically coupled to the waveguide layer 300. In an embodiment, the optical transmission assembly 40 may be coupled to the carrier surface 201 and optically edge coupled to the edge of the waveguide layer 300 of the photonic chip 30.

In an embodiment, the optical module 1 may further include a plurality of bumps 60 (see FIG. 5). In an embodiment, the photonic chip 30 may be electrically connected to the substrate 10 through the bumps 60. In an embodiment, the presence of the bumps 60 may indicate that the photonic chip 30 is flip-chip bonded to the mounting surface 110, and in this case, the bumps 60 may be understood as solder balls.

In an embodiment, thermal deformation of the substrate 10 may lead to the recessed space 120 expanding or shrinking, which may affect the optical path structure. In this embodiment, the sizes of the first flanges 210 of the second body 200 can help minimize the negative impact caused by such deformation. In an embodiment, the first flanges 210 of the second body 200 may have larger dimensions to ensure sufficient bonding strength between the first flanges 210 and the first body 100 of the substrate 10, thereby minimizing the negative impact caused by deformation.

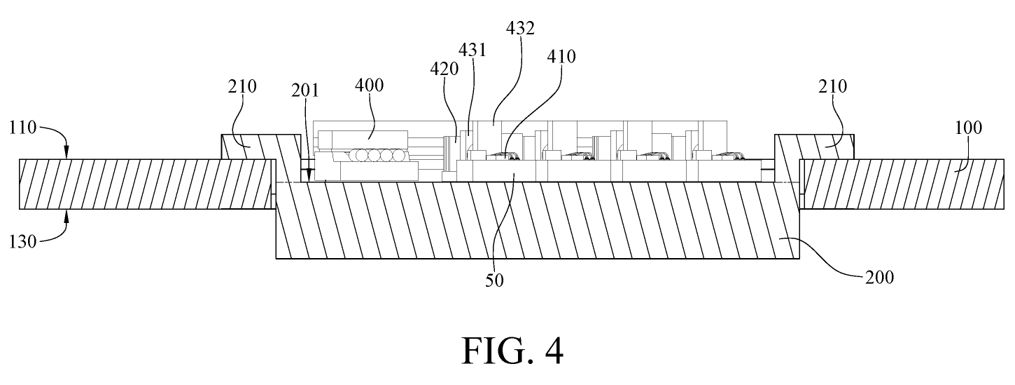

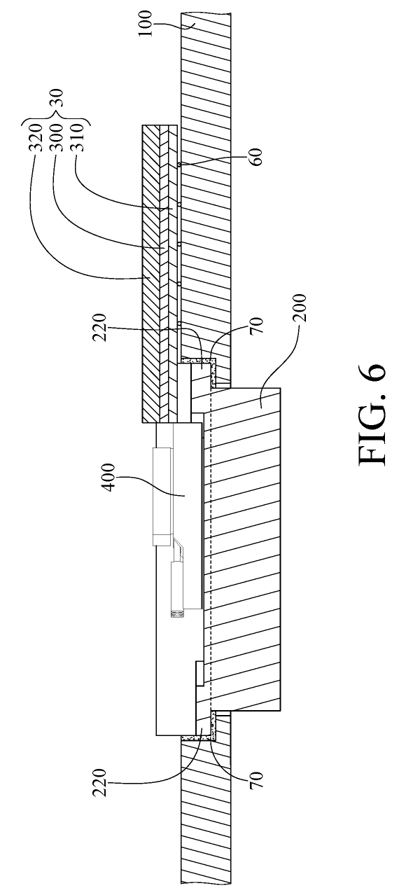

FIG. 4 is a cross-sectional diagram along the line 4-4 in FIG. 3. FIG. 5 is a cross-sectional diagram along the line 5-5 in FIG. 3. FIG. 6 is a cross-sectional diagram along the line 6-6 in FIG. 3.

In an embodiment, the optical transmission assembly 40 may include an optical fiber array 400, multiple optical transmission units 410, multiple optical isolators 420, and multiple lens assemblies 430. The optical transmission units 410 may be laser diodes or photodiodes. In an embodiment, the laser diodes or photodiodes may be mounted on the submount. In the case where the optical transmission assembly 40 is edge coupled to the optical waveguide layer 300, an additional optical coupler may be configured between the optical isolators 420 and the optical waveguide layer 300.

In an embodiment, the optical fiber array 400 may be optically coupled to the emission end of the photonic chip 30. In an embodiment, a coupling matching adhesive may be filled between the optical fiber array 400 and the optical waveguide layer 300 of the photonic chip 30.

In an embodiment, these optical transmission units 410 may be optically coupled to the edge of the optical waveguide layer 300. In an embodiment, an optical bench may be mounted on the carrier surface 201 to optimize the horizontal level of the optical transmission units 410, thereby ensuring the optical coupling efficiency between the transmission units 410 and the optical waveguide layer 300.

In an embodiment, these optical transmission units 410 may be optically coupled to the incident end of the photonic chip 30 through these optical isolators 420 and lens assemblies 430. In this embodiment, the lens assemblies 430 can ensure successful optical coupling even when the position of the optical waveguide layer 300 of the photonic chip 30 cannot be confirmed. In an embodiment, these lens assemblies 430 may include a first lens 431 and a second lens 432.

In an embodiment, the optical module 1 may further include multiple heat dissipation members 50. In an embodiment, these heat dissipation members 50 may be respectively arranged to correspond to each of the optical transmission units 410.

According to an embodiment of the optical module in the present disclosure, the optical module may be applied to an optical transceiver. The optical transceiver may include a housing, with the optical module accommodated in the housing. The substrate of the optical module may be exposed from the housing to allow electrical connection between the substrate and an external circuitry in a network device such as optical switch. The optical transceiver may also include an optical fiber receptacle, such as a LC receptacle or a MPO receptacle, which optically couples with the photonic chip 30 of the optical module.

In view of the above description, according to the optical module disclosed in the embodiment of the present disclosure, at least a portion of the carrier is within the recessed space of the substrate, and the cladding layer of the photonic chip faces and coupled to the mounting surface of the substrate. Therefore, the reliability of the optical module can be enhanced. Specifically, the reliability of optical coupling can be improved.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

What is claimed is:

1. An optical module, comprising:
a substrate comprising a first body, wherein the first body has a mounting surface and a recessed space, and the recessed space is recessed from the mounting surface;
a carrier comprising a second body and two first flanges, wherein the second body has a carrier surface, the two first flanges are respectively disposed on opposite sides of the second body, the two first flanges are coupled to the mounting surface of the substrate, and at least a portion of the second body is disposed within the recessed space;
a photonic chip comprising a waveguide layer and a cladding layer stacked with each other, wherein the cladding layer faces and coupled to the mounting surface of the substrate, and the photonic chip and the carrier are spatially separated from each other; and
an optical transmission assembly coupled to the carrier surface and optically coupled to the waveguide layer.

2. The optical module of claim 1, wherein the photonic chip further comprises a substrate layer, the waveguide layer is disposed between the substrate layer and the cladding layer, and a distance between the waveguide layer and the cladding layer is less than a distance between the waveguide layer and the substrate layer.

3. The optical module of claim 1, wherein the first body further comprises two engagement portions, the carrier further comprises two second flanges, the two engagement portions are respectively disposed on opposite sides of the recessed space, the two second flanges are respectively disposed on opposite sides of the second body, the two second flanges are disposed corresponding to the two engagement portions with the two first flanges not corresponding to the two engagement portions.

4. The optical module of claim 3, wherein the two second flanges are disposed between the two first flanges and the second body in a thickness direction, and a structural adhesive is between the two second flanges and the two engagement portions.

5. The optical module of claim 1, wherein a portion of the waveguide layer covers a portion of the recessed space.

6. The optical module of claim 1, wherein the optical transmission assembly comprises a plurality of light transmission units, and the plurality of light transmission units are edge coupled to the waveguide layer.

7. The optical module of claim 1, wherein in a thickness direction of the substrate, the mounting surface is between the waveguide layer and the carrier surface.

8. The optical module of claim 1, further comprising a plurality of conductive bumps, wherein the photonic chip is electrically connected to the substrate through the plurality of conductive bumps.

9. An optical module, comprising:
a substrate comprising a first body, wherein the first body has a mounting surface, a back surface, and a recessed space, the mounting surface and the back surface are opposite to each other, and the recessed space is recessed from the mounting surface;
a carrier comprising a second body, wherein the second body has a carrier surface, at least a portion of the second body is disposed within the recessed space, and the carrier surface is disposed between the mounting surface and the back surface;
a photonic chip coupled to the mounting surface of the substrate by flip-chip bonding; and
an optical transmission assembly coupled to the carrier surface and edge coupled to a waveguide layer of the photonic chip.

10. The optical module of claim 9, wherein the photonic chip comprises a cladding layer, a waveguide layer, and a substrate layer, the cladding layer faces and coupled to the mounting surface of the substrate, the waveguide layer is disposed between the substrate layer and the cladding layer, and a distance between the waveguide layer and the cladding layer is less than a distance between the waveguide layer and the substrate layer.

11. The optical module of claim 9, wherein the carrier further comprises two first flanges, the two first flanges are respectively disposed on opposite sides of the second body, and the two first flanges are coupled to the mounting surface of the substrate.

12. The optical module of claim 11, wherein the first body further comprises two engagement portions, the carrier further comprises two second flanges, the two engagement portions are respectively disposed on opposite sides of the recessed space, the two second flanges are respectively disposed on opposite sides of the second body, the two second flanges are disposed corresponding to the two engagement portions with the two first flanges not corresponding to the two engagement portions.

13. The optical module of claim 12, wherein the two second flanges are disposed between the two first flanges and the second body, and a structural adhesive is between the two second flanges and the two engagement portions.

14. The optical module of claim 9, wherein a portion of the waveguide layer covers a portion of the recessed space.

15. The optical module of claim 9, wherein the photonic chip and the carrier are spatially separated from each other.
